(19) United States
(12) Patent Application Publication
(10) Pub. No.: US 2014/0201648 A1
(43) Pub. Date: Jul. 17, 2014

(54) DISPLAYING HOTSPOTS IN RESPONSE TO MOVEMENT OF ICONS

(71) Applicant: INTERNATIONAL BUSINESS MACHINES CORPORATION, Armonk, NY (US)

(72) Inventors: Michael J. Branson, Rochester, MN (US); Gregory R. Hintermeister, Rochester, MN (US)

(73) Assignee: International Business Machines Corporation, Armonk, NY (US)

(21) Appl. No.: 13/743,912

(22) Filed: Jan. 17, 2013

(51) Int. Cl. H04L 29/08; G06F 3/0481

(52) U.S. Cl. CPC H04L 67/26; G06F 3/04817
USPC 715/748

(57) ABSTRACT

In an embodiment, in response to selection of an content icon on a user I/O device, a plurality of candidate recipients of content are determined. In response to movement of the content icon on the user I/O device, a plurality of hotspots are displayed on the user I/O device that represent the plurality of candidate recipients. In response to movement of the content icon over a first hotspot of the plurality of hotspots, content and an identifier of an application that created the content are sent to a target device used by a first candidate recipient represented by the first hotspot.

### FIELD

An embodiment of the invention generally relates to electronic devices and more particularly to electronic devices with user interfaces that send content to target devices.

### BACKGROUND

Computer systems typically comprise a combination of computer programs and hardware, such as semiconductors, transistors, chips, circuit boards, storage devices, and processors. The computer programs are stored in the storage devices and are executed by the processors.

One use of computer systems is in a technology known as surface based or touch computing, in which users interact with a touch screen or other surface to interact with digital content through gestures and touch. The display area of surface-based computing devices may vary from relatively small areas, such as that of a telephone, to medium sized areas, such as a small desk or video screen, to relatively large areas, such as a conference table surface. The touch screen may use a variety of technologies, such as projectors to project images onto a surface and cameras to detect gestures.

### SUMMARY

A method, processor-readable storage medium, and electronic device are provided. In an embodiment, in response to selection of an content icon on a user I/O (Input/Output) device, a plurality of candidate recipients of content are determined. In response to movement of the content icon on the user I/O device, a plurality of hotspots are displayed on the user I/O device that represent the plurality of candidate recipients. In response to movement of the content icon over a first hotspot of the plurality of hotspots, content and an identifier of an application that created the content are sent to a target device used by a first candidate recipient represented by the first hotspot.

### BRIEF DESCRIPTION OF THE SEVERAL VIEWS OF THE DRAWINGS

FIG. 1 depicts a high-level block diagram of an example system for implementing an embodiment of the invention.

FIG. 2 depicts a block diagram of an example user I/O device prior to the display of hotspots, according to an embodiment of the invention.

FIG. 3 depicts a block diagram of an example user I/O device after the display of hotspots, according to an embodiment of the invention.

FIG. 4 depicts a flowchart of example processing for hotspots, according to an embodiment of the invention.

FIG. 5 depicts a flowchart of example processing for determining candidate recipients, according to an embodiment of the invention.

It is to be noted, however, that the appended drawings illustrate only example embodiments of the invention, and are therefore not considered a limitation of the scope of other embodiments of the invention.

### DETAILED DESCRIPTION

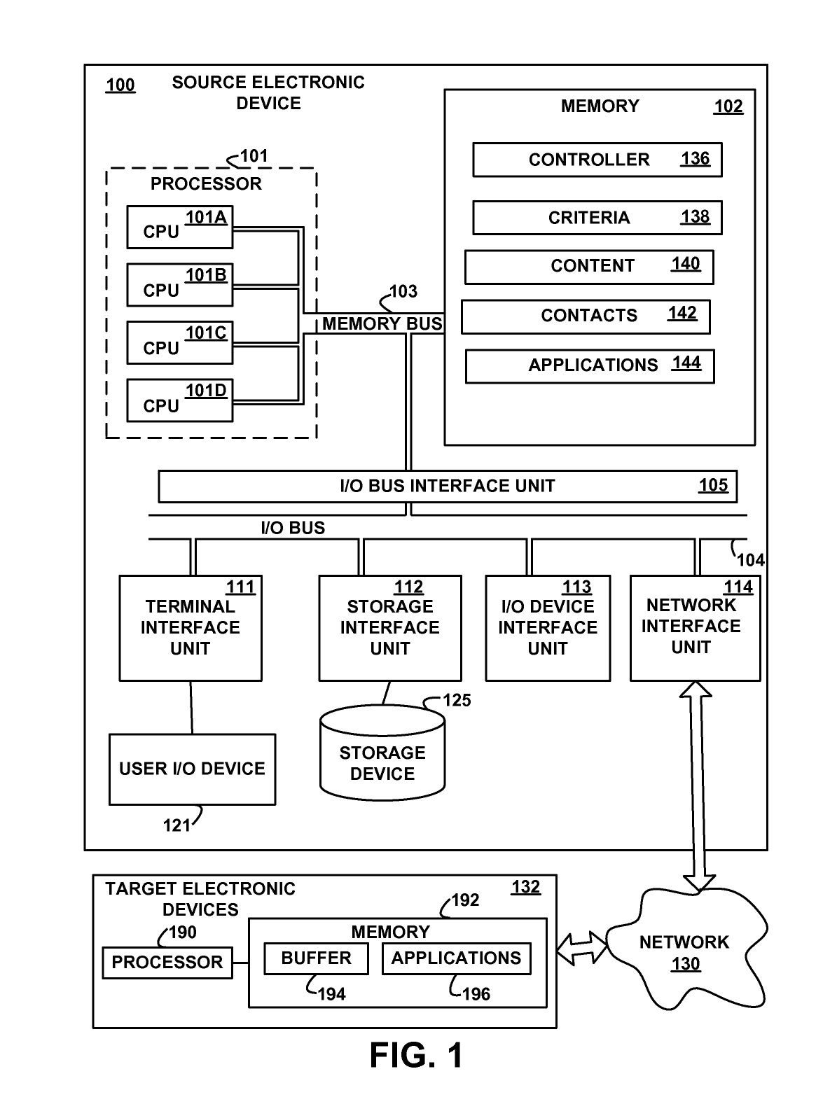

Referring to the Drawings, wherein like numbers denote like parts throughout the several views, FIG. 1 depicts a high-level block diagram representation of a source electronic device 100 connected to target electronic devices 132 via a network 130, according to an embodiment of the present invention. The terms “source” and “target” are used herein for convenience only, and in various embodiments an electronic device that operates as a source in one environment may operate as a target in another environment, and vice versa. The mechanism and apparatus of embodiments of the present invention apply equally to any appropriate electronic devices or computing systems.

The major components of the electronic device 100 comprise one or more processors 101, a memory 102, a terminal interface unit 111, a storage interface unit 112, an I/O (Input/Output) device interface unit 113, and a network interface unit 114, all of which are communicatively coupled, directly or indirectly, for inter-component communication via a memory bus 103, an I/O bus 104, and an I/O bus interface unit 105.

The electronic device 100 contains one or more general-purpose programmable central processing units (CPUs) 101A, 101B, 101C, and 101D, herein generically referred to as the processor 101. In an embodiment, the electronic device 100 contains multiple processors typical of a relatively large system; however, in another embodiment the electronic device 100 may alternatively be a single CPU system. Each processor 101 executes instructions stored in the memory 102 and may comprise one or more levels of on-board cache.

In an embodiment, the memory 102 may comprise a random-access semiconductor memory, storage device, or storage medium (either volatile or non-volatile) for storing or encoding data and programs. In another embodiment, the memory 102 represents the entire virtual memory of the electronic device 100, and may also include the virtual memory of other electronic devices coupled to the electronic device 100 or connected via the network 130. The memory 102 is conceptually a single monolithic entity, but in other embodiments the memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 102 stores or encodes a controller 136, criteria 138, content 140, contacts 142, and applications 144. Although the controller 136, the criteria 138, the content 140, the contacts 142, and the applications 144 are illustrated as being contained within the memory 102 in the electronic device 100, in other embodiments some or all of them may be on different electronic devices and may be accessed remotely, e.g., via the network 130. The electronic device 100 may use virtual addressing mechanisms that allow the programs of the electronic device 100 to behave as if they only have access to a large, single storage entity instead of access to multiple, smaller storage entities. Thus, while the controller 136, the criteria 138, the content 140, the contacts 142, and the applications 144 are illustrated as being contained within the memory 102, these elements are not necessarily all completely contained in the same storage device at the same time. Further, although the controller 136, the criteria 138, the content 140, the contacts 142, and the applications 144 are illustrated as being separate entities, in other embodiments some of them, portions of some of them, or all of them may be packaged together.

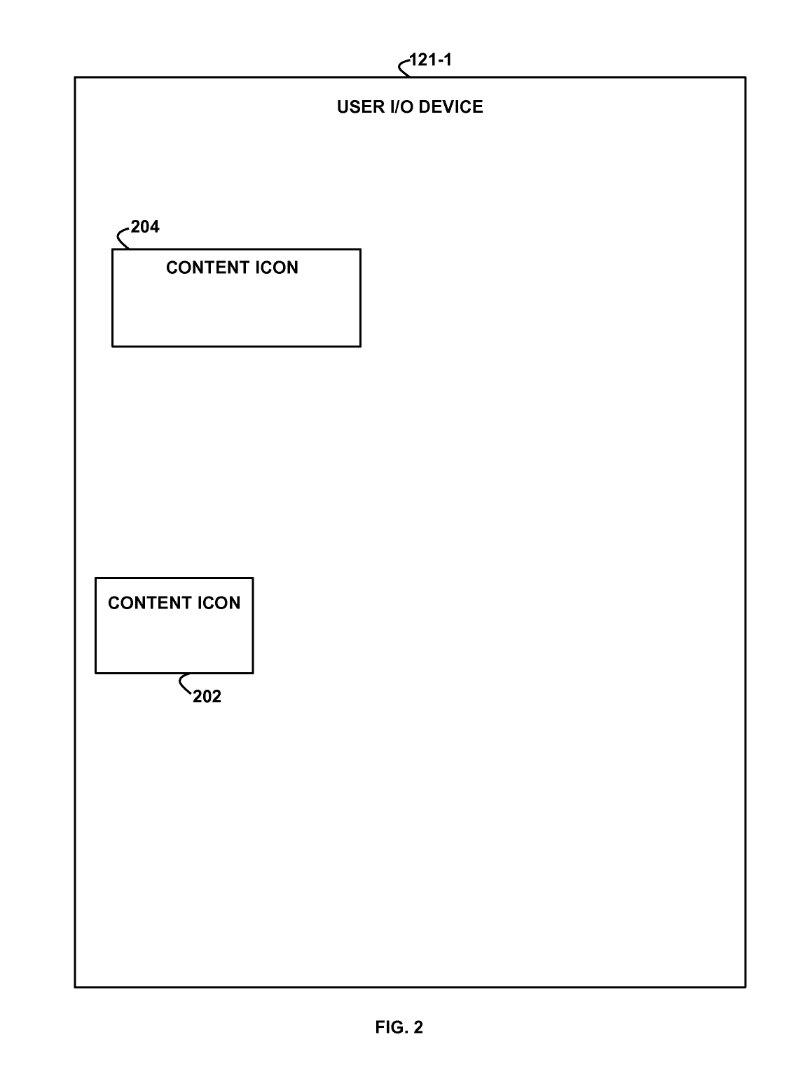

In an embodiment, the controller 136 and/or the applications 144 comprise instructions or statements that execute on the processor 101 or instructions or statements that are interpreted by instructions or statements that execute on the processor 101, to carry out the functions as further described below with reference to FIGS. 2, 3, 4, and 5. In another embodiment, the controller 136 and/or the applications 144 are implemented in hardware via semiconductor devices, chips, logical gates, circuits, circuit cards, and/or other physical hardware devices in lieu of, or in addition to, a processor-based system. In an embodiment, the controller 136 comprises data in addition to instructions or statements. In various embodiments, the controller 136 and/or the applications 144 are user applications, third-party applications, operating systems, or any portion, multiple, or combination thereof.

The criteria 138 specifies the criteria, conditions, rules, or characteristics that members of a group of users must possesses, in order for the controller 136 to select the members of a group as candidate recipients of the content 140. Examples of the criteria 138 include, but are not limited to availability of the user based on calendar, the physical presence of a target electronic device 132 near (within a threshold distance) the source electronic device 100, frequency of contact between a user of the source electronic device 100 and the group member, and/or most recent time of contact or exchange of messages between the source electronic device 100 and the group member. In various embodiments, the controller 136 may detect that a candidate recipient is nearby (within a threshold distance) using RFID (Radio Frequency Identification) technology, NFC (Near Field Communication) technology, GPS (Global Positioning) technology, or any other appropriate technique. In various embodiments, the content 140 comprises data, audio, video, text, characters, photographs, drawings, control tags, formatting tags, executable code, or any multiple, portion, or combination thereof. In various embodiments, the controller 136 receives the criteria 138 and the content 140 from the user I/O device 121, from the I/O device interface unit 113, or from the network 130 and stores the criteria 138 and the content 140 to the memory 102.

The contacts 142 comprise identifiers of users at the electronic devices 132. In an embodiment, the contacts 142 also comprise respective position or location information assigned to each of the respective identifiers of the users. The controller 136 reads the respective position or location information, and in response, displays a respective hotspot that represents the respective assigned user at the respective location on the user I/O device 121 specified by the contacts 142. In an embodiment, the controller 136 selects candidate recipients of the content 140 from among the contacts 142. The identifiers may comprise names, nicknames, user names, telephone numbers, email addresses, network addresses, domains, or any portion, combination, or multiple thereof. The contacts 142 may specify groups of user identifiers, where user identifiers are members of a group. Examples of groups may be all users who have a specified role, skills, or occupation, such as friend, doctor, nurse, on call operator, or guitar playing. In various embodiments, the controller 136 receives the contacts 142 from the user I/O device 121, from the I/O device interface unit 113, or from the network 130 and stores the contacts 142 to the memory 102.

The memory bus 103 provides a data communication path for transferring data among the processor 101, the memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104.

The I/O interface units support communication with a variety of storage and I/O devices. For example, the terminal interface unit 111 supports the attachment of one or more user I/O devices 121, which may comprise user output devices (such as a video display device, projectors, a speaker, and/or television set) and user input devices (such as a camera, a keyboard, a mouse, a keypad, a touchpad, a trackball, buttons, Radio Frequency Identifier Tags, a light pen, a finger, a stylus, or other pointing device). A user may manipulate the user input devices using a user interface, in order to provide input data and commands to the user I/O device 121 and the electronic device 100, and may receive output data via the user output devices. For example, a user interface may be presented via the user I/O device 121, such as displayed on a display device. The user I/O device 121 may be of any size and may accommodate multiple users viewing and touching the user I/O device 121 simultaneously or collaboratively, and in an embodiment, any user may touch at any location on the user I/O device 121. The electronic device 100 may distinguish between users that touch the user I/O device 121 via a ring, watch, or wristband worn by the different users, by different fingerprints of the different users, or by facial recognition via a camera.

When a user touches a portion of the user I/O device 121 with a finger or stylus, the user I/O device 121 sends an input signal corresponding to the content displayed on the display device below the touched portion to the terminal interface 111, which relays the signal to the controller 136. In various embodiments, the user I/O device 121 may be implemented as a resistive overlay touch screen, an infrared touch screen, an ultrasonic touch screen, or a capacitive touch screen, or any other appropriate type of touch screen. In another embodiment, the user may interact with the user I/O device 121 with a mouse, keyboard, touchpad, or any pointing device.

In an embodiment, a resistive overlay touch screen comprises two panels coated with transparent electrode layers that are soldered to each other with an interposed dot spacer, so that the transparent electrode layers face each other. Electric signals are applied to one side of the transparent electrode to detect a touch location. In response to the upper transparent electrode being brought into contact with the lower transparent electrode by a touch, a corresponding electric signal occurs, and the terminal interface 111 determines coordinates of the touch location using the detected electric signal. In an embodiment, an infrared touch screen comprises infrared sensors including an infrared ray emitting element and a receiving element for receiving infrared signals from the emitting element. The infrared touch screen determines coordinates of a touch location by connection or disconnection of signals depending on being touched. In an embodiment, an ultrasonic touch screen determines a touch location by transmission and reception of ultrasonic waves along a touch surface. In an embodiment, a capacitive touch screen comprises electrode plates on a substrate, with voltage applied to the electrode plates. In response to a conductive substance touching one of the electrode plates, parasitic capacitance occurs in response to permittivity between the conductive substance. The capacitive touch screen measures the capacitance and determines coordinates of the touch location from the capacitance.

The storage interface unit 112 supports the attachment of one or more disk drives or direct access storage devices 125 (which are typically rotating magnetic disk drive storage devices, although they could alternatively be other storage devices, including arrays of disk drives configured to appear as a single large storage device to a host computer). In another embodiment, the storage device 125 may be implemented via any type of secondary storage device. The contents of the memory 102, or any portion thereof, may be stored to and retrieved from the storage device 125, as needed. The I/O device interface unit 113 provides an interface to any of various other input/output devices or devices of other types, such as printers, fax machines, or antenna. In various embodiments, the I/O device interface unit 113 may implement RFID (Radio Frequency Identification) technology, NFC (Near Field Communication) technology, or GPS (Global Positioning) technology. The network interface unit 114 provides one or more communications paths from the electronic device 100 to other digital devices and electronic devices 132; such paths may comprise, e.g., one or more networks 130.

Although the memory bus 103 is shown in FIG. 1 as a relatively simple, single bus structure providing a direct communication path among the processors 101, the memory 102, and the I/O bus interface unit 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 105 and the I/O bus 104 are shown as single respective units, the electronic device 100 may, in fact, contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

In various embodiments, the electronic device 100 is a multi-user mainframe computer system, a single-user system, or a server computer or similar device that has little or no direct user interface, but receives requests from computer systems (clients). In other embodiments, the electronic device 100 is implemented as a desktop computer, portable computer, laptop or notebook computer, tablet computer, pocket computer, telephone, smart phone, pager, automobile, teleconferencing system, appliance, or any other appropriate type of electronic device.

The network 130 may be any suitable network or combination of networks and may support any appropriate protocol suitable for communication of data and/or code to/from the electronic device 100 and the electronic device 132. In various embodiments, the network 130 may represent a storage device or a combination of storage devices, either connected directly or indirectly to the electronic device 100. In another embodiment, the network 130 may support wireless communications. In another embodiment, the network 130 may support hard-wired communications, such as a telephone line or cable. In another embodiment, the network 130 may be the Internet and may support IP (Internet Protocol). In another embodiment, the network 130 is implemented as a local area network (LAN) or a wide area network (WAN). In another embodiment, the network 130 is implemented as a hotspot service provider network. In another embodiment, the network 130 is implemented an intranet. In another embodiment, the network 130 is implemented as any appropriate cellular data network, cell-based radio network technology, or wireless network. In another embodiment, the network 130 is implemented as any suitable network or combination of networks. Although one network 130 is shown, in other embodiments any number of networks (of the same or different types) may be present.

The electronic device 132 may comprise some or all of the hardware and/or computer program elements of the electronic device 100. In particular, the electronic device 132 comprises a processor 190 (with a description analogous to the processor 101) communicatively connected to the memory 192 (with a description analogous to the memory 102). The memory 192 stores a buffer 194 and applications 196 (with a description analogous to the applications 144). In an embodiment, the buffer 194 is in shared memory, that is, the buffer 194 is in a portion of the memory 192 that is shared between different applications 196. In an embodiment, the buffer 194 is implemented as a copy/cut/paste buffer that multiple different applications 196 use to copy or move data between the applications 196, in response to selection and commands from a user of the electronic device 132.

FIG. 1 is intended to depict the representative major components of the electronic device 100, the network 130, and the electronic device 132. But, individual components may have greater complexity than represented in FIG. 1, components other than or in addition to those shown in FIG. 1 may be present, and the number, type, and configuration of such components may vary. Several particular examples of such additional complexity or additional variations are disclosed herein; these are by way of example only and are not necessarily the only such variations. The various program components illustrated in FIG. 1 and implementing various embodiments of the invention may be implemented in a number of manners, including using various computer applications, routines, components, programs, objects, modules, data structures, etc., and are referred to hereinafter as “computer programs,” or simply “programs.”

The computer programs comprise one or more instructions or statements that are resident at various times in various memory and storage devices in the electronic device 100 and that, when read and executed by one or more processors in the electronic device 100 or when interpreted by instructions that are executed by one or more processors, cause the electronic device 100 to perform the actions necessary to execute steps or elements comprising the various aspects of embodiments of the invention. Aspects of embodiments of the invention may be embodied as a system, method, or computer program product. Accordingly, aspects of embodiments of the invention may take the form of an entirely hardware embodiment, an entirely program embodiment (including firmware, resident programs, micro-code, etc., which are stored in a storage device) or an embodiment combining program and hardware aspects that may all generally be referred to herein as a “circuit,” “module,” or “system.” Further, embodiments of the invention may take the form of a computer program product embodied in one or more computer-readable medium(s) having computer-readable program code embodied thereon.

Any combination of one or more computer-readable medium(s) or processor-readable medium(s) may be utilized. The computer-readable medium may be a computer-readable signal medium or a computer-readable storage medium. A computer-readable storage medium, may be, for example, but not limited to, an electronic, magnetic, optical, electromagnetic, infrared, or semiconductor system, apparatus, or device, or any suitable combination of the foregoing. More specific examples (an non-exhaustive list) of the computer-readable storage media may comprise: an electrical connection having one or more wires, a portable computer diskette, a hard disk (e.g., the storage device 125), a random access memory (RAM) (e.g., the memory 102), a read-only memory (ROM), an erasable programmable read-only memory (EPROM) or Flash memory, an optical fiber, a portable compact disc read-only memory (CD-ROM), an optical storage device, a magnetic storage device, or any suitable combination of the foregoing. In the context of this document, a computer-readable storage medium may be any tangible medium that can contain, or store, a program for use by or in connection with an instruction execution system, apparatus, or device.

A computer-readable signal medium may comprise a propagated data signal with computer-readable program code embodied thereon, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagates, or transports a program for use by, or in connection with, an instruction execution system, apparatus, or device. Program code embodied on a computer-readable medium may be transmitted using any appropriate medium, including but not limited to, wireless, wire line, optical fiber cable, Radio Frequency, or any suitable combination of the foregoing.

Computer program code for carrying out operations for aspects of embodiments of the present invention may be written in any combination of one or more programming languages, including object oriented programming languages and conventional procedural programming languages. The program code may execute entirely on the user's computer, partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of embodiments of the invention are described below with reference to flowchart illustrations and/or block diagrams of methods, apparatus (systems), and computer program products. Each block of the flowchart illustrations and/or block diagrams, and combinations of blocks in the flowchart illustrations and/or block diagrams may be implemented by computer program instructions embodied in a computer-readable medium. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified by the flowchart and/or block diagram block or blocks. These computer program instructions may also be stored in a computer-readable medium that direct a computer, other programmable data processing apparatus, or other devices to function in a particular manner, such that the instructions stored in the computer-readable medium produce an article of manufacture, including instructions that implement the function/act specified by the flowchart and/or block diagram block or blocks.

The computer programs defining the functions of various embodiments of the invention may be delivered to a computer system via a variety of tangible computer-readable storage media that may be operatively or communicatively connected (directly or indirectly) to the processor or processors. The computer program instructions may also be loaded onto a computer, other programmable data processing apparatus, or other devices to cause a series of operational steps to be performed on the computer, other programmable apparatus, or other devices to produce a computer-implemented process, such that the instructions, which execute on the computer or other programmable apparatus, provide processes for implementing the functions/acts specified in the flowcharts and/or block diagram block or blocks.

The flowchart and the block diagrams in the figures illustrate the architecture, functionality, and operation of possible implementations of systems, methods, and computer program products, according to various embodiments of the present invention. In this regard, each block in the flowcharts or block diagrams may represent a module, segment, or portion of code, which comprises one or more executable instructions for implementing the specified logical function(s). In some embodiments, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flow chart illustrations, may be implemented by special purpose hardware-based systems that perform the specified functions or acts, in combinations of special purpose hardware and computer instructions.

Embodiments of the invention may also be delivered as part of a service engagement with a client corporation, nonprofit organization, government entity, or internal organizational structure. Aspects of these embodiments may comprise configuring a computer system to perform, and deploying computing services (e.g., computer-readable code, hardware, and web services) that implement, some or all of the methods described herein. Aspects of these embodiments may also comprise analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention are not limited to use solely in any specific application identified and/or implied by such nomenclature. The exemplary environments illustrated in FIG. 1 are not intended to limit the present invention. Indeed, other alternative hardware and/or program environments may be used without departing from the scope of embodiments of the invention.

FIG. 2 depicts a block diagram of an example user I/O device 121-1 prior to the display of hotspots, according to an embodiment of the invention. The user I/O device 121-1 is an example of, and is generically referred to by, the user I/O device 121 (FIG. 1). The user I/O device 121-1 displays content icons, such as the example content icons 202 and 204. In various embodiments, a content icon is identical to the content 140, represents or identifies the content 140, comprises a subset or a portion of the content 140, or is derived from the content 140. For example, the content 140 may comprise executable code, data, control codes, formatting tags, or any portion, multiple, or combination thereof while the content icon comprises data formatted or displayed using the executable code, control codes, or formatting tags. In various embodiment, the content icons 202 and 204 are different portions of the content 140, represent different portions of the content 140, are derived from different portions of the content 140, or are displayed using different portions of the content 140. The user may select the content icon 202 or the content icon 204 and may move the selected content icon 202 or 204 to different locations on the user I/O device 121-1.

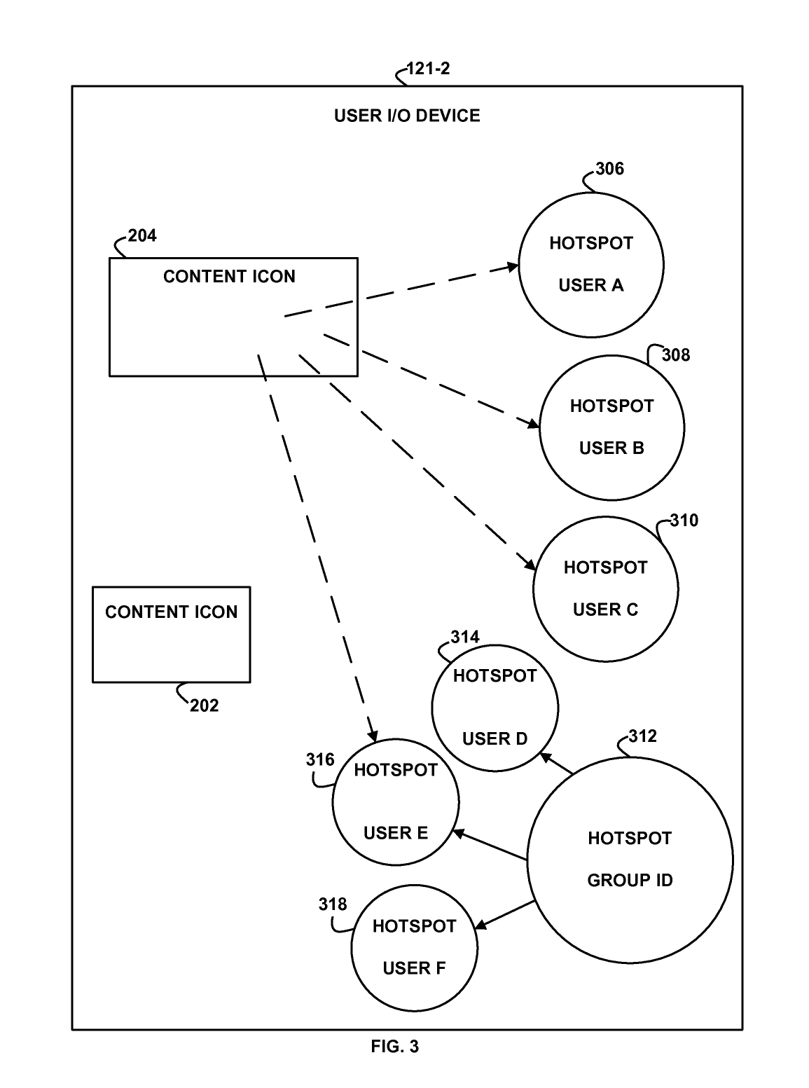

FIG. 3 depicts a block diagram of an example user I/O device 121-2 after the display of hotspots, according to an embodiment of the invention. The user I/O device 121-2 is an example of, and is generically referred to by, the user I/O device 121 (FIG. 1). The user I/O device 121-2 displays the content icon 202, the content icon 204, and example hotspots 306, 308, 310, 312, 314, 316, and 318. A hotspot is an icon or screen area that represents and identifies a candidate recipient or recipients or a group of candidate recipients of content represented by the content icon 204, identical to the content icon 204, or from which the content icon 204 is derived and may also represent or identify the target electronic device or devices used by the candidate recipient or recipients. The hotspot 312 represents a group of member users, and the controller 136 filters the group of users to produce the candidate recipients (represented by the hotspots 314, 316, and 318) that meet, best meet, or most closely satisfy, the criteria 138. The controller 136 then displays the individual hotspots 314, 316, and 318, but does not display individual hotspots for members of the group hotspot 312 that do not meet the criteria 138. The controller 136 displays the hotspots 306, 308, 310, 312, 314, 316, and 318 in response to movement of the content icon 204 and sends the content represented by the content icon 204 to the user represented by the hotspot over which the content icon 204 is moved.

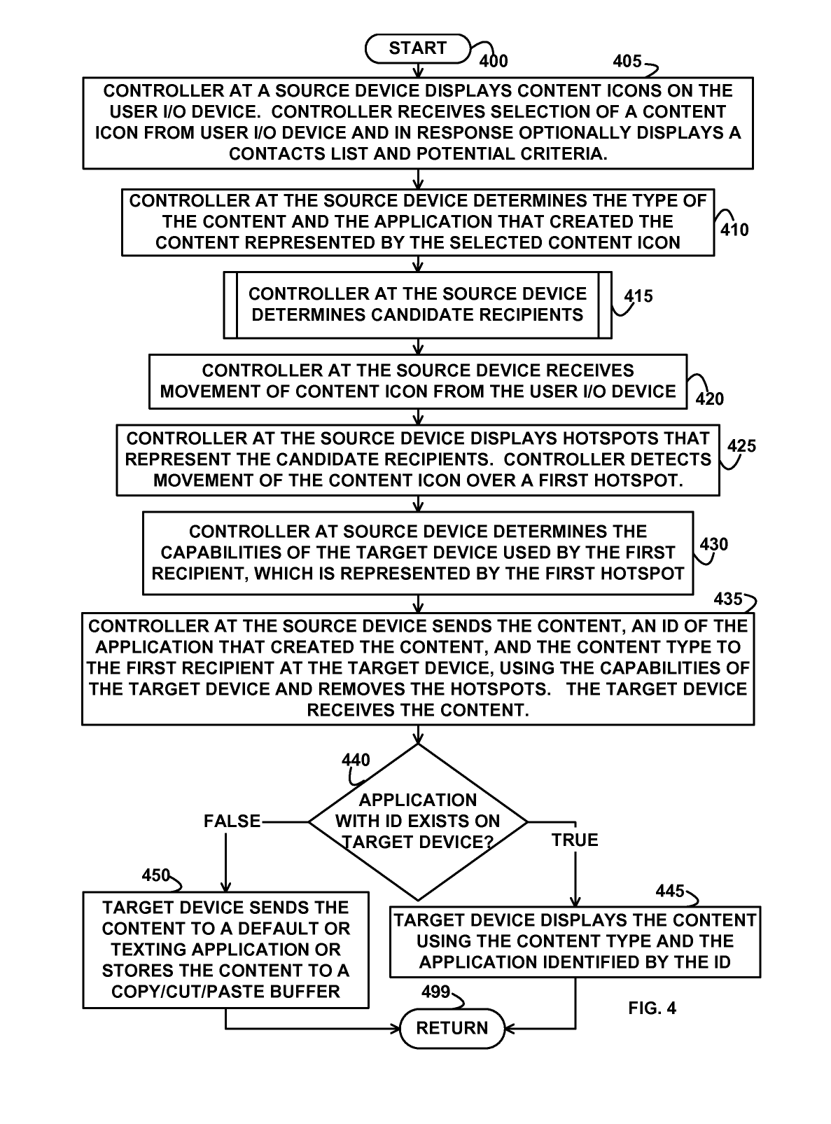

FIG. 4 depicts a flowchart of example processing for hotspots, according to an embodiment of the invention. Control begins at block 400. Control then continues to block 405 where the controller 136 at a source electronic device 100 displays content icons on the user I/O device 121. In various embodiments, the content icons represent the content 140, are a subset of the content 140, are derived from the content 140, or are identical to the content 140. The controller 136 receives selection of a content icon from the user I/O device 121 and, in response, optionally displays the contacts 142 and the criteria 138.

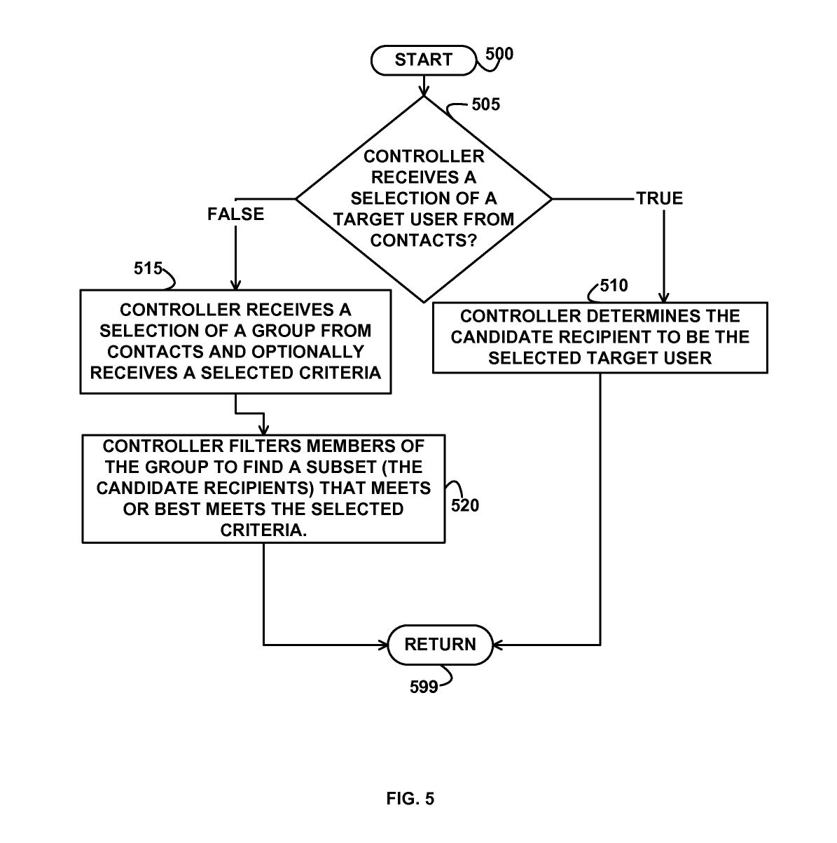

Control then continues to block 410 where the controller 136 at the source electronic device 100 determines the type of the content 140 and the application 144 that created the content 140 represented by or that is the selected content icon, or from which the selected content icon is derived or displayed. Examples of the type of the content 140 may include a document, text, audio, video, characters, or any other appropriate type. In an embodiment, the controller 136 determines the type of the content 140 by reading the file extension of the content 140. Control then continues to block 415 where the controller 136 at the source electronic device 100 determines candidate recipients of the content 140, as further described below with reference to FIG. 5. Referring again to FIG. 4, control then continues to block 420 where the controller 136 at the source electronic device 100 receives a signal from the user I/O device 121, which indicates movement of a content icon displayed on the user I/O device 121. Control then continues to block 425 where the controller 136 at the source electronic device 100 displays hotspots on the user I/O device 121 that represent the determined candidate recipients or a group that has users for members. The controller 136 further detects movement of the content icon over, on, or adjacent to a first hotspot.

Control then continues to block 430 where the controller 136 at the source electronic device 100 determines the capabilities of the target electronic device 132 used by the first recipient, which is represented by the first hotspot. In various embodiments, the capabilities comprise the communications protocol used by the target electronic device 132, the connection speed supported by the target electronic device 132 and/or the network 130, and/or the size of the streaming buffer of the electronic device 132. In various embodiments, the controller 136 determines the capabilities of the target electronic device 132 by requesting and receiving them from the target electronic device 132 or by receiving them from a server computer connected to the network 130.

Control then continues to block 435 where the controller 136 at the source electronic device 100 sends the content 140, an identifier of the application 144 that created the content 140, and the content type to the first recipient at the target electronic device 132, using the capabilities of the target electronic device 132. For example, the controller 136 at the source electronic device 100 sends the content 140 (that is represented by the selected content icon, that is identical to the selected content icon, or from which the selected content icon is derived or displayed) to the target electronic device 132 using the communications protocol supported by the target electronic device 132 at the speed supported by the network connection and the streaming buffer 194 of the target electronic device 132. If the first hotspot is a group hotspot, such as the hotspot 312, then the controller sends (broadcasts) the content 140 to all of the members of the group. The controller 136 further removes all the hotspots from the source electronic device 100, in response to the sending. The target electronic device(s) 132 receives the content 140.

Control then continues to block 440 where the target electronic device 132 determines whether an application 196 with the received identifier (that created the received content) exists on the target electronic device 132. If the determination at block 440 is true, then the application 196 with the received identifier (that created the received content) exists on the target electronic device 132, so control continues to block 445 where the target electronic device 132 executes the application 196 identified by the received application identifier to display the received content 140, using the received content type. Control then continues to block 499 where the logic of FIG. 4 returns.

If the determination at block 440 is false, then the application 196 with the received identifier (that created the received content) does not exist on the target electronic device 132, so control continues to block 450 where the target electronic device 132 sends the content 140 to a default application or a texting application or stores the content 140 to a copy/cut/paste buffer 194. In various embodiments, the target electronic device may send the content 140 to the default or texting application as plain text, rich text or a snapshot image of the content. In an embodiment, the first recipient at the target electronic device 132 selects the application 196 that receives, processes, and/or displays the received content 140. Control then continues to block 499 where the logic of FIG. 4 returns.

FIG. 5 depicts a flowchart of example processing for determining candidate recipients, according to an embodiment of the invention. Control begins at block 500. Control then continues to block 505 where the controller 136 at the source electronic device 100 determines whether the source electronic device 100 has received a selection of a target user from the contacts 142 via the user I/O device 121. If the determination at block 505 is true, then the controller 136 at the source electronic device 100 has received a selection of a target user from the contacts 142 via the user I/O device 121, so control continues to block 510 where the controller 136 at the source electronic device 100 determines the candidate recipient to be the selected target user. Control then continues to block 599 where the logic of FIG. 5 returns.

If the determination at block 505 is false, then the controller 136 at the source electronic device 100 has not received a selection of a target user from the contacts 142, so control continues to block 515 where the controller 136 at the source electronic device 100 receives a selection of a group from the contacts 142 via the user I/O device 121 and optionally receives a selected criteria 138. Control then continues to block 520 where the controller 136 at the source electronic device 100 filters members of the group to find a subset of the members of the group that meets or best meets the selected criteria 138 while excluding those members from the subset that do not meet or do not best meet the selected criteria 138.

For example, if the selected criteria 138 specifies availability of the user based on calendar, then the controller 136 finds the subset that meets or best meets the selected criteria 138 to be the users that are currently available or not busy, as specified by their calendars. As another example, if the selected criteria 138 specifies the physical presence of a target electronic device 132 near (within a threshold distance) the source electronic device 100, then the controller 136 finds the subset that meets or best meets the selected criteria 138 to be the users who are within the threshold distance of the source electronic device. As another example, if the selected criteria 138 specifies frequency of contact between the user of the source electronic device 100 and the group member, then the controller 136 finds the subset that meets or best meets the selected criteria 138 to be the users that have a history of the most frequent contact (over a period of time) or more than a threshold frequency of contact (exchange of messages) with the user of the source electronic device 100. As another example, if the selected criteria 138 specifies most recent time of contact or exchange of messages between the source electronic device 100 and the group member, then the controller 136 finds the subset that meets or best meets the selected criteria 138 to be the users that have a history (over a period of time) of the most recent time of contact or less than a threshold amount of time since the most recent contact. In various embodiments, the controller 136 receives various thresholds and periods of time from the user I/O device 121, from the network 130, or from one or more of the target electronic devices 132. In another embodiment, the various thresholds and periods of time are set by a designer of the controller 136.

Control then continues to block 599 where the logic of FIG. 5 returns.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, embodiments of the invention may be practiced without these specific details. In other instances, well-known circuits, structures, and techniques have not been shown in detail in order not to obscure embodiments of the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense.

What is claimed is:

1. A method comprising:
in response to selection of an content icon on a user I/O device, determining a plurality of candidate recipients of content;
in response to movement of the content icon on the user I/O device, displaying a plurality of hotspots on the user I/O device that represent the plurality of candidate recipients; and
in response to movement of the content icon over a first hotspot of the plurality of hotspots, sending content and an identifier of an application that created the content to a target device used by a first candidate recipient represented by the first hotspot.

2. The method of claim 1, wherein the content icon represents the content.

3. The method of claim 1, wherein the content icon and the content are identical.

4. The method of claim 1, wherein the content icon is a subset of the content.

5. The method of claim 1, wherein if the application identified by the identifier exists at the target device, the target device invokes the application to display the content, wherein if the application identified by the identifier does not exist at the target device, the target device stores the content to shared memory accessed by a plurality of applications at the target device, and wherein the first candidate recipient at the target device selects one of the plurality of applications to read the content from the shared memory.

6. The method of claim 1, wherein the determining the plurality of candidate recipients further comprises:
receiving a selection of a group that comprises members; and
filtering the members of the group to find a subset of the members that best meets a selected criteria, wherein the plurality of hotspots represent the group and a subset of the members that best meets the selected criteria;
displaying a plurality of criteria in response to the selection of the content icon on the user I/O device; and
receiving the selected criteria from among the plurality of criteria.

7. The method of claim 6, further comprising:
in response to movement of the content icon over one of the plurality of hotspots that represents the group, sending the content to all of the members of the group.

8. The method of claim 1, further comprising:
removing the plurality of hotspots in response to the sending the content and the identifier of the application; and
in response to movement of the content icon over the first hotspot of the plurality of hotspots, determining a capability of the target device, wherein the sending the content to the target device uses the capability.

9. A processor-readable storage medium encoded with instructions, wherein the instructions when executed comprise:
in response to selection of an content icon on a user I/O device, determining a plurality of candidate recipients of content, wherein the determining the plurality of candidate recipients further comprises receiving a selection of a group that comprises members and filtering the members of the group to find a subset of the members that best meets a selected criteria, wherein a plurality of hotspots represent the group and a subset of the members that best meets the selected criteria, displaying a plurality of criteria in response to the selection of the content icon on the user I/O device, and receiving the selected criteria from among the plurality of criteria;
in response to movement of the content icon on the user I/O device, displaying the plurality of hotspots on the user I/O device that represent the plurality of candidate recipients; and
in response to movement of the content icon over a first hotspot of the plurality of hotspots, sending content and an identifier of an application that created the content to a target device used by a first candidate recipient represented by the first hotspot.

10. The processor-readable storage medium of claim 9, wherein the content icon represents the content.

11. The processor-readable storage medium of claim 9, wherein the content icon and the content are identical.

12. The processor-readable storage medium of claim 9, wherein the content icon is a subset of the content.

13. The processor-readable storage medium of claim 9, wherein if the application identified by the identifier exists at the target device, the target device invokes the application to display the content, wherein if the application identified by the identifier does not exist at the target device, the target device stores the content to shared memory accessed by a plurality of applications at the target device, and wherein the first candidate recipient at the target device selects one of the plurality of applications to read the content from the shared memory.

14. The processor-readable storage medium of claim 9, further comprising:
in response to movement of the content icon over one of the plurality of hotspots that represents the group, sending the content to all of the members of the group.

15. The processor-readable storage medium of claim 9, further comprising:
removing the plurality of hotspots in response to the sending the content and the identifier of the application; and
in response to movement of the content icon over the first hotspot of the plurality of hotspots, determining a capability of the target device, wherein the sending the content to the target device uses the capability.

16. A source electronic device comprising:
a user I/O device;
a processor communicatively coupled to the user I/O device; and
memory communicatively coupled to the processor, wherein the memory is encoded with instructions, wherein the instructions when executed by the processor comprise
in response to selection of an content icon on a user I/O device, determining a plurality of candidate recipients of content, wherein the determining the plurality of candidate recipients further comprises receiving a selection of a group that comprises members and filtering the members of the group to find a subset of the members that best meets a selected criteria, wherein a plurality of hotspots represent the group and a subset of the members that best meets the selected criteria, displaying a plurality of criteria in response to the selection of the content icon on the user I/O device, and receiving the selected criteria from among the plurality of criteria,
in response to movement of the content icon on the user I/O device, displaying the plurality of hotspots on the user I/O device that represent the plurality of candidate recipients,
in response to movement of the content icon over a first hotspot of the plurality of hotspots, sending the content and an identifier of an application that created the content to a target device used by a first candidate recipient represented by the first hotspot,
in response to movement of the content icon over one of the plurality of hotspots that represents the group, sending content to all of the members of the group and removing the plurality of hotspots from the user I/O device, and
in response to movement of the content icon over a first hotspot of the plurality of hotspots, determining a capability of the target device, wherein the sending the content to the target device uses the capability.

17. The source electronic device of claim 16, wherein the content icon represents the content.

18. The source electronic device of claim 16, wherein the content icon and the content are identical.

19. The source electronic device of claim 16, wherein the content icon is a subset of the content.

20. The source electronic device of claim 16, wherein if the application identified by the identifier exists at the target device, the target device invokes the application to display the content, wherein if the application identified by the identifier does not exist at the target device, the target device stores the content to shared memory accessed by a plurality of applications at the target device, and wherein the first candidate recipient at the target device selects one of the plurality of applications to read the content from the shared memory.
